(19) United States
(12) Patent Application Publication
(10) Pub. No.: US 2025/0357023 A1
(43) Pub. Date: Nov. 20, 2025

(54) Cable and Cable Assembly

(71) Applicants: Tyco Electronics (Dongguan) Ltd., Dongguan City (CN); Tyco Electronics (Shanghai) Co., Ltd., Shanghai (CN)

(72) Inventors: Zhiwei (Jack) Guo, Dongguan (CN); Chaofeng Wang, Dongguan (CN)

(73) Assignees: Tyco Electronics (Dongguan) Ltd., Dongguan City (CN); Tyco Electronics (Shanghai) Co., Ltd., Shanghai (CN)

(21) Appl. No.: 19/209,296

(22) Filed: May 15, 2025

(30) Foreign Application Priority Data
May 15, 2024 (CN) 202410606780.8

(51) Int. Cl. H01B 11/10; H01B 7/02; H01B 7/18; H01B 11/00; H01B 11/08

(52) U.S. Cl. CPC H01B 11/1008; H01B 7/0225; H01B 7/1805; H01B 11/005; H01B 11/08; H01B 11/1091

(57) ABSTRACT

A cable includes at least two conductive wire cores spaced apart from each other and extending in a longitudinal direction of the cable, and an interior insulation structure circumferentially wrapped around and contacting each of the at least two conductive wire cores to fix the at least two conductive wire cores. The interior insulation structure is a foamed insulation structure in which the at least two conductive wire cores are fixedly maintained. The cable further includes an internal insulation layer wrapped over and contacting the interior insulation structure on an outer side of the interior insulation structure, a first conductive shielding layer wrapped over the internal insulation layer on an outer side of the internal insulation layer, and an external insulation layer wrapped over an outside of the first conductive shielding layer.

### CROSS-REFERENCE TO RELATED APPLICATION

This application claims the benefit of the filing date under 35 U.S.C. § 119(a)-(d) of Chinese Patent Application No. 202410606780.8, filed on May 15, 2024.

### FIELD OF THE INVENTION

Embodiments of the present disclosure generally relate to a cable, and more particularly, to a cable with improved electrical performance stability, and a cable assembly including the cable.

### BACKGROUND OF THE INVENTION

A conventional structure of a data transmission cable mainly includes at least two insulated wire cores, a conductive shielding layer, and an outer insulation layer. However, the conventional structure of the cable is unstable, and the capacitance, impedance, etc. of the two wire cores may not match to each other in use, resulting in poor electrical performance stability, especially the signal integrity (“SI”) performance being adversely affected in the case of high-speed data transmission. Improvement is needed to address these issues.

### SUMMARY OF THE INVENTION

A cable includes at least two conductive wire cores spaced apart from each other and extending in a longitudinal direction of the cable, and an interior insulation structure circumferentially wrapped around and contacting each of the at least two conductive wire cores to fix the at least two conductive wire cores. The interior insulation structure is a foamed insulation structure in which the at least two conductive wire cores are fixedly maintained. The cable further includes an internal insulation layer wrapped over and contacting the interior insulation structure on an outer side of the interior insulation structure, a first conductive shielding layer wrapped over the internal insulation layer on an outer side of the internal insulation layer, and an external insulation layer wrapped over an outside of the first conductive shielding layer.

### BRIEF DESCRIPTION OF THE DRAWINGS

The invention will now be described by way of example with reference to the accompanying figures, of which:

FIG. 1 is a cross-sectional view schematically showing a structure of a cable according to an exemplary embodiment of the present disclosure;

FIG. 2 is a cross-sectional view schematically showing a structure of a cable according to another exemplary embodiment of the present disclosure;

FIG. 3 is a cross-sectional view schematically showing a structure of a cable according to a further exemplary embodiment of the present disclosure;

FIG. 4 is a cross-sectional view schematically showing a structure of a cable according to a further exemplary embodiment of the present disclosure; and

FIG. 5 is a cross-sectional view schematically showing a structure of a cable assembly according to an exemplary embodiment of the present disclosure.

### DETAILED DESCRIPTION

Example embodiments of the present disclosure will be described hereinafter in detail with reference to the accompanying drawings. However, it should be understood that these descriptions are merely exemplary, and do not necessarily limit the scope of the present disclosure. In the drawings, the same or similar parts are indicated by the same or similar reference numerals. In the following detailed description, for purposes of explanation, numerous specific details are set forth in order to provide a thorough understanding of the disclosed embodiments. It will be apparent, however, that one or more embodiments may be practiced without these specific details. In addition, well-known structures and devices are schematically shown in order to simplify the drawing, and descriptions of well-known structures and technologies are omitted, to avoid confusing the concept of the present disclosure unnecessarily.

The term used herein is for the purpose of describing specific embodiments only and is not intended to limit the present disclosure. The terms “including”, “comprising”, “having”, etc. used herein indicate the presence of the described features, steps, operations, and/or components, but do not exclude the existence or addition of one or more other features, steps, operations, or components.

All terms (including technical and scientific terms) used herein have the meanings commonly understood by those skilled in the art, unless otherwise defined. It should be noted that the terms used herein should be interpreted as having a meaning consistent with the context of the present description, and should not be interpreted in an idealized or overly rigid manner.

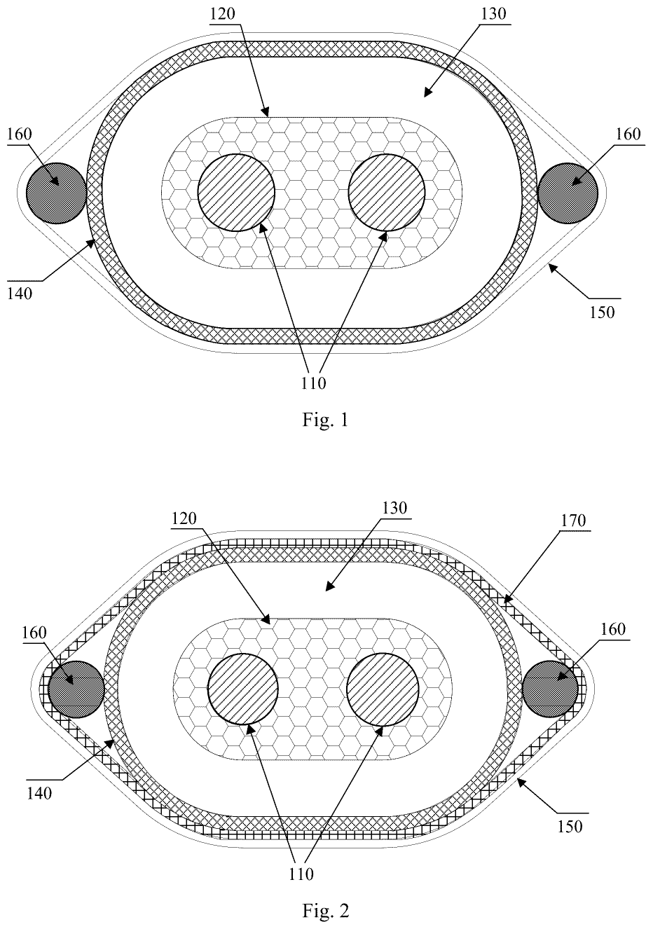

As shown in FIGS. 1-5, according to exemplary embodiments of the present disclosure, there is provided a cable, such as a 112G cable, which is capable of stably transmitting data at a higher transmission rate and is applicable for interface modules such as OSFP, QSFP-DD, SFP, SFP-DD, CDFP, etc.

The cable according to the embodiments of the present disclosure may include at least two conductive wire cores 110 for transmitting signals or data, which are arranged to be spaced apart from each other and electrically insulated from each other (via a single interior insulation structure described below), and extend longitudinally or axially. Herein, the conductive wire core 110 is made of a conductive material and does not include any insulation material or is not insulated, for example, the conductive wire core 110 is only composed of a conductor. As an example, each conductive wire core 110 may be made of a high-conductivity material such as a copper conductor, a silver-plated conductor or the like. Each conductive wire core 110 may be a single core wire formed by a single conductor, or a twisted core wire formed by two or more conductors, which is not specifically limited in the present disclosure.

In the exemplary embodiments shown in FIGS. 1-4, the cable further includes an interior insulation structure 120 extending longitudinally or axially along the conductive wire cores 110, and circumferentially wrapped around each conductive wire core 110 and contacting (e.g., bonding to) an outer circumferential surface of each conductive wire core 110 so as to provide electrical insulation and protection function for the conductive wire core. As an example, the interior insulation structure 120 may be made of an insulation material such as polyester, polyethylene, polypropylene, polyvinyl chloride, polytetrafluoroethylene, polyperfluoro ethylene-propylene, polyvinylidene fluoride, tetrafluoroethylene, ethylene copolymer, polyolefin, polyethylene terephthalate (“PET”), etc.

The interior insulation structure 120 is used to fix the relative position between the individual conductive wire cores 110, that is, the individual conductive wire cores 110 are fixedly maintained within the interior insulation structure 120. In a conventional cable, an insulation layer is wound around or bonded to an outside of each conductor to form an insulated core wire, and outer circumferences of the insulation layers of the adjacent insulated core wires are abutted against each other. There will be a gap between the adjacent insulated core wires, which causes the cable structure to be easily deformed or the core wire to be easily displaced, thus the data transmission performance is unstable.

Unlike the conventional cable, in the embodiments of the present disclosure, all of the conductive wire cores 110 of the same cable are wrapped by the single interior insulation structure 120, the material of the interior insulation structure 120 is filled between the wrapped conductive wire cores 110, and the interior insulation structure 120 and all of the conductive wire cores 110 wrapped therein form a stable integrated structure, which can ensure that each conductive wire core 110 will not be displaced relative to other conductive wire cores in use, such as during assembling, bending, and other operations, and the cable structure will not be deformed or less deformed, thereby improving the stability of the cable performance. In other words, the relatively fixed position of the conductors forming the individual conductive wire cores in the single interior insulation structure may ensure that the cable has a stable structure to achieve the stable electrical performance. As an example, a spacing between the individual conductive wire cores 110 of the cable may remain unchanged or constant in the longitudinal direction of the cable.

In embodiments of the present disclosure, the interior insulation structure 120 is a single foamed insulation structure, i.e., it is formed by a foamed insulation material, in which the individual conductive wire cores 110 are fixedly maintained, that is, the individual conductive wire cores of the cable are wrapped in the same or a single foamed insulation structure and spaced apart from each other to be electrically insulated from each other. Illustratively, the foamed insulation structure may include a porous insulation structure or an insulation structure in which bubbles or pores are formed. According to embodiments of the present disclosure, by wrapping the foamed insulation material around each conductive wire core 110, especially directly wrapping over the conductive wire core or the conductor itself to form a foamed insulation structure, a dielectric constant of the cable can be significantly reduced, such that characteristics of the cable could meet requirements of better communication effects, wherein electrical characteristics such as electrostatic capacity, capacitance balance, far (near) end crosstalk and attenuation can be significantly improved, which is advantageous for high-speed and high-frequency signal transmission. Moreover, the weight and size of the cable product can be lighter and smaller, thereby optimizing the transmission performance of the cable. Chemical foaming process or physical foaming process may be used to prepare the interior insulation structure, which is not specifically limited in the present disclosure.

According to exemplary embodiments of the present disclosure, the interior insulation structure 120 may be an integrated structure formed by an extrusion process, which is directly formed (extruded) over the outer circumferential surfaces of the conductive wire cores 110 in the longitudinal or axial direction of the cable. In other words, unlike conventional techniques where the insulation layer is separately extruded over a single wire core to form an insulated wire core, the exemplary embodiments of the present disclosure proposes that the foamed insulation material is extruded at a time to be directly wrapped around two or more conductive wire cores or conductors themselves, so as to form an integrated insulation structure, such as a foamed insulation structure, which extends continuously along the length of the cable so that the insulation structure is more closely fitted over the outer circumferential surface of each conductive wire core or conductor, the stability of the structure is better, and the cable can be prepared more efficiently by a single extrusion.

In the illustrated embodiments, as shown in FIGS. 1-5, the interior insulation structure 120 may have a generally elliptical cross-section, and two conductive wire cores 110 are symmetrically maintained in the interior insulation structure 120. The two conductive wire cores 110 may be spaced apart along a long axis direction of the elliptical shape, for example, centers of the two conductive wire cores 110 may coincide with two focal points of the elliptical shape, respectively. However, the present disclosure is not limited to this, and the cross-sectional shape of the interior insulation structure, the arrangement of the conductive wire cores, etc. may be changed according to actual needs.

In exemplary embodiments of the present disclosure, as shown in the cross-sectional views of FIGS. 1-5, the cable further includes an internal insulation layer 130, a first conductive shielding layer (or tape) 140, and an external insulation layer (or tape) 150 arranged in sequence from inside to outside, each extending along the length or longitudinal direction of the cable. The internal insulation layer 130 is circumferentially wrapped over and contacts an outer circumferential surface of the interior insulation structure 120 to stably support the interior insulation structure 120 and the conductive wire cores 110 maintained therein; the first conductive shielding layer (or tape) 140 is circumferentially wrapped over or surrounds the internal insulation layer 130 to provide signal shielding for the conductive wire cores, and the external insulation layer 150 is wrapped over an outside of the first conductive shielding layer 140 to provide protection.

Illustratively, the internal or external insulation layer 130, 150 may be made of an insulation material such as polyester, polyethylene, polypropylene, polyvinyl chloride, polytetrafluoroethylene, polyperfluoro ethylene-propylene, polyvinylidene fluoride, tetrafluoroethylene, ethylene copolymer, polyolefin, polyethylene terephthalate (“PET”), etc. In addition, in some embodiments, an insulation tape may be used to be wound around the outer circumferential surface of the interior insulation structure; or, an internal insulation layer is also formed over the outer circumferential surface of the interior insulation structure by an extrusion molding process. As the interior insulation structure 120 is an integrated structure that firmly maintain each conductive wire core 110 therein, the internal insulation layer 130 can be formed over the interior insulation structure 120 more stably and consistently. For example, the internal insulation layer 130 has a uniform distribution and thickness over the interior insulation structure 120, so that the structure and electrical characteristics of the cable are more stable, ensuring better signal integrity (“SI”) performance.

In some embodiments, a dielectric constant of the interior insulation structure 120 may be less than or equal to that of the internal insulation layer 130. As an example, the internal insulation layer 130 may be formed from foamed material that is the same or different from the material of the interior insulation structure 120 to further reduce the dielectric constant of the cable. Alternatively, according to specific requirements, the internal insulation layer 130 can be formed from solid or non-foamed insulation material to improve the stability of the cable structure, i.e., the solid or non-foamed internal insulation layer may have higher strength to stably support and protect the interior insulation structure 120 and the conductive wire cores 110, so that the cable is not easily deformed during operations such as bending, extruding in the mold, or assembling, in order to maintain the high and stable SI performance.

In the illustrated embodiments, as shown in the cross-sectional views of FIGS. 1-5, the internal insulation layer 130 is a ring-shaped layer surrounding the interior insulation structure 120, for example, it may be formed as a tubular structure extending along the length of the cable, and may have a uniform layer thickness. However, the present disclosure is not limited to this, and the cross-sectional shape and thickness, etc. of the internal insulation layer 130 may be changed according to actual needs.

In some embodiments of the present disclosure, unlike a spirally wrapping arrangement of the conductive shielding layer in the conventional cable, the first conductive shielding layer 140 in the form of a full-longitudinally wrapping or a semi-longitudinally wrapping may be fitted or wrapped over the outer circumferential surface of the internal insulation layer 130 by using a mold. The first conductive shield layer 140 in the form of the longitudinally wrapping may be a half or full tubular structure that is circumferentially wrapped over the internal insulation layer 130 and extends along the length or longitudinal direction of the cable, which can be better fitted (e.g., bonded by hot melting or by an adhesive) over the internal insulation layer 130, thereby improving the stability of the SI performance of the cable, eliminating the pitch of the conventional spirally wrapping structure, further eliminating the overall echo loss caused by the spirally wrapping structure, and improving the frequency bandwidth of the cable, thereby meeting the requirements of the high-speed data transmission. The first conductive shielding layer 140 may include a metal shielding layer or tape, such as an insulation tape layer or tape, and a conductive layer (such as a metal layer) attached to the insulation tape layer or tape. Illustratively, the external insulation layer (or tape) 150 may include an insulation layer or tape in the form of a spirally wrapping or a longitudinally wrapping.

In some embodiments, as shown in FIGS. 1-3 and 5, the cable may further include a separate drain wire or grounding wire 160, such as at least one drain wire or grounding wire 160 provided between the first conductive shielding layer (or tape) 140 and the external insulation layer (or tape) 150. The drain wire or grounding wire 160 may be in electrical contact with the first conductive shielding layer 140 to enhance the electromagnetic shielding effect of the cable. For example, the conductive layer of the first conductive shielding layer (or tape) 140 may face outwardly towards the external insulation layer (or tape) 150 to make contact with the drain wire or grounding wire 160.

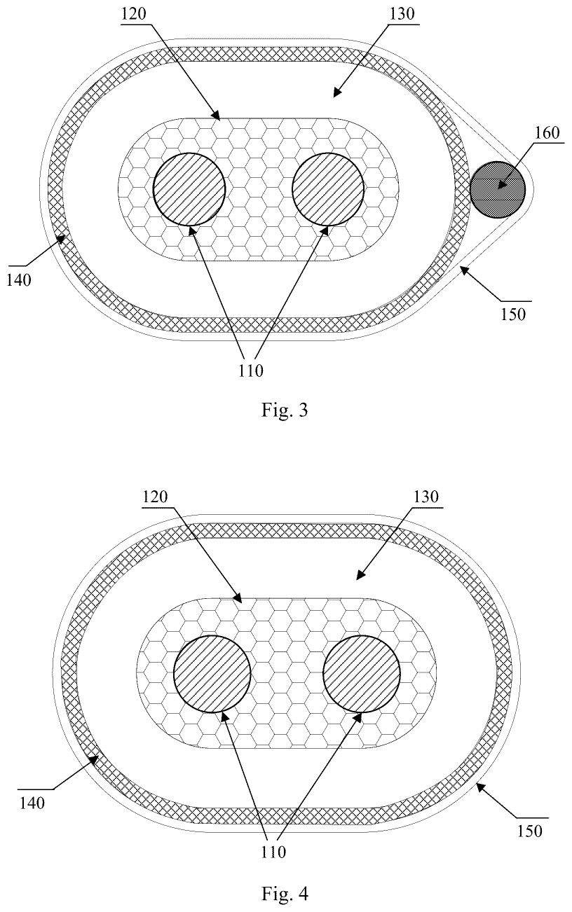

In the embodiments illustrated in FIGS. 1, 2 and 5, two grounding wires 150 are provided, which are symmetrically provided on diametrically opposed sides of the first conductive shielding layer (or tape) 140, for example. In FIG. 3, only a single grounding wire 150 is provided on one side of the first conductive shielding layer (or tape) 140. And in the embodiment shown in FIG. 4, no separate drain wire or grounding wire is provided, and in this case, the first conductive shielding layer 140 may be electrically connected to an external grounding structure and thus function as a grounding wire. In some examples, the grounding wire 150 is diametrically aligned with the conductive wire cores 110, for example, centers of the grounding wire and the conductive wire cores may be located within approximately the same plane. Although in the illustrated embodiments, the grounding wire 150 is shown as having a circular cross-section, the present disclosure is not limited to this. In other embodiments, the grounding wire 150 may have a flat structure or a layered structure attached to the conductive shielding layer 140.

In the embodiment shown in FIG. 2, the cable may further include a second conductive shielding layer (or tape) 170 wrapped around outsides of the first conductive shielding layer (or tape) 140 and the at least one grounding wire 160, the at least one grounding wire 160 being positioned between the first conductive shielding layer (or tape) 140 and the second conductive shielding layer (or tape) 170 and in electrical contact with at least one of the first conductive shielding layer (or tape) 140 and the second conductive shielding layer (or tape) 170, and the external insulation layer 150 being wrapped over an outside of the second conductive shielding layer (or tape) 170 to fix the conductive shielding layer (or tape) and the grounding wire therein. This double-layer shielding structure may enhance the overall electromagnetic compatibility (“EMC”) and electromagnetic interference (“EMI”) capabilities of the cable, further improving the stability of the electrical performance of the cable. The second conductive shielding layer (or tape) 170 may adopt a similar structure to the first conductive shielding layer (or tape) 140, such as a longitudinally wrapping structure, but the present disclosure is not limited to this.

As an example, each of the first conductive shielding layer (or tape) 140 and the second conductive shielding layer (or tape) 170 may include an insulation tape layer or tape, and a conductive layer adhered to the insulation tape layer or tape, and the conductive layers of the first conductive shielding layer (or tape) 140 and the second conductive shielding layer (or tape) 170 face and contact each other, and are in electrical contact with the grounding wire 160 located therebetween.

In the case where the conductive shielding layer adopts a longitudinally wrapping structure, the position of the grounding wire 160 of the cable may be fixed on a central line of the longitudinally wrapping structure using the mold. For example, the grounding wire 160 may be adhered to a surface of the longitudinally wrapping structure by an adhesive layer, such as an adhesion coating, adhesive, or hot melt adhesive provided on the surface of the longitudinally wrapping structure, thus, the conductive shielding layer in the form of the longitudinally wrapping can be better fitted and wrapped over the grounding wire 160, so that the grounding wire 160 can be stably fixed. The grounding wire 160 basically extends or fixed in position in a straight line along the longitudinal or axial direction of the cable, that is, the position offset of the grounding wire 160 within the longitudinal or length range of the cable is reduced or eliminated, further improving the SI performance of the cable.

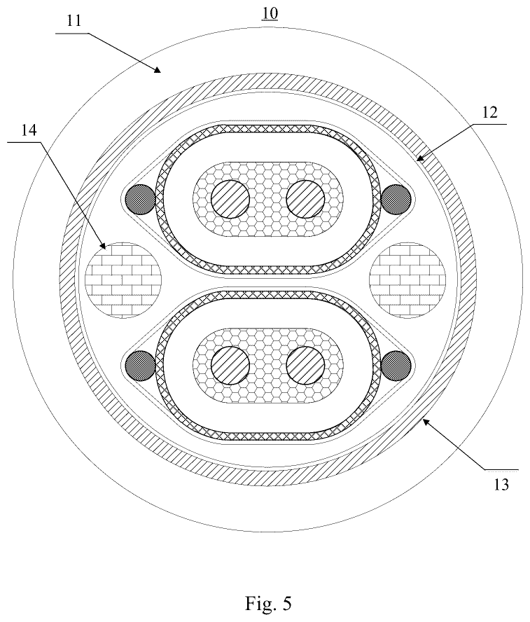

According to an embodiment of the present disclosure, there is also provided a cable assembly, as shown in FIG. 5, the cable assembly including at least two cables described herein, which may be arranged within an outer sheath 11. For example, these cables may be parallel, spaced apart, twisted or wound with respect to each other in the longitudinal direction.

The outer sheath 11 may be in the form of a sleeve, such as a metal or plastic tube, to provide protection function for an interior structure of the cable. As shown, the cable assembly 10 may further include an electromagnetic shielding structure 12 provided within the outer sheath 11, and the electromagnetic shielding structure 12 may take the form of a layer or tape of metal or other conductive material and wrapped or wound around an outside of all of the cables to provide further improved electromagnetic shielding effect.

In some examples, as shown in FIG. 5, the cable assembly may further include an additional buffering layer 13, such as a braided layer, which is provided within the outer sheath 11, for example, arranged between the electromagnetic shielding structure 12 and the outer sheath 11 in an annular form, to provide buffering or vibration damping function for the cables. In other examples, a space between the cables and/or a space between the cables and the buffering layer 13 or the shielding structure within the outer sheath may be further at least partially filled with a filler 14, so that the structure of the cable assembly will not be easily deformed and remains stable in use.

Although the example embodiments of the present disclosure have been shown and described, it would be appreciated by those skilled in the art that various changes may be made to these embodiments without departing from the principles and spirit of the disclosure, the scope of which is defined by the appended claims and their equivalents. Thus, those skilled in the art will understand that in case of no conflict, the features recorded in the various embodiments and/or claims of the present disclosure may be combined or integrated in various ways, even if such combinations or integrations are not explicitly recorded in the present disclosure. Specifically, without departing from the spirit and teachings of the present disclosure, the features recorded in the various embodiments and/or claims of the present disclosure may be combined and/or integrated in various ways. All these combinations and/or integrations fall within the scope of the present disclosure.

1. A cable, comprising:
at least two conductive wire cores spaced apart from each other and extending in a longitudinal direction of the cable;
an interior insulation structure circumferentially wrapped around and contacting each of the at least two conductive wire cores to fix the at least two conductive wire cores, the interior insulation structure being a foamed insulation structure in which the at least two conductive wire cores are fixedly maintained;
an internal insulation layer wrapped over and contacting the interior insulation structure on an outer side of the interior insulation structure;
a first conductive shielding layer wrapped over the internal insulation layer on an outer side of the internal insulation layer; and
an external insulation layer wrapped over an outside of the first conductive shielding layer.

2. The cable according to claim 1, wherein the at least two conductive wire cores are wrapped within the same foamed insulation structure.

3. The cable according to claim 2, wherein the interior insulation structure is an integrally extruded structure formed over an outer circumferential surface of each of the at least two conductive wire cores along the longitudinal direction of the cable.

4. The cable according to claim 3, wherein the interior insulation structure has an elliptical cross-section, and the at least two conductive wire cores include a pair of conductive wire cores symmetrically disposed within the interior insulation structure.

5. The cable according to claim 4, wherein a spacing between the pair of conductive wire cores is constant along the longitudinal direction of the cable.

6. The cable according to claim 1, wherein a dielectric constant of the interior insulation structure is less than or equal to that of the internal insulation layer.

7. The cable according to claim 6, wherein the internal insulation layer is a ring-shaped layer formed by a solid insulation material.

8. The cable according to claim 1, wherein each of the at least two conductive wire cores is a single core wire formed by a single conductor or a twisted core wire formed by two or more conductors.

9. The cable according to claim 1, further comprising at least one grounding wire provided between the first conductive shielding layer and the external insulation layer, the at least one grounding wire is in electrical contact with the first conductive shielding layer.

10. The cable according to claim 2, further comprising at least one grounding wire provided between the first conductive shielding layer and the external insulation layer, the at least one grounding wire is in electrical contact with the first conductive shielding layer.

11. The cable according to claim 3, further comprising at least one grounding wire provided between the first conductive shielding layer and the external insulation layer, the at least one grounding wire is in electrical contact with the first conductive shielding layer.

12. The cable according to claim 5, further comprising at least one grounding wire provided between the first conductive shielding layer and the external insulation layer, the at least one grounding wire is in electrical contact with the first conductive shielding layer.

13. The cable according to claim 6, further comprising at least one grounding wire provided between the first conductive shielding layer and the external insulation layer, the at least one grounding wire is in electrical contact with the first conductive shielding layer.

14. The cable according to claim 9, wherein the at least one grounding wire is a single grounding wire positioned on one side of the first conductive shielding layer, or two grounding wires symmetrically arranged on two opposite sides of the first conductive shielding layer.

15. The cable according to claim 9, further comprising a second conductive shielding layer wrapped over the first conductive shielding layer and the at least one grounding wire on outer sides of the first conductive shielding layer and the at least one grounding wire.

16. The cable according to claim 15, wherein the external insulation layer is wrapped over the second conductive shielding layer.

17. The cable according to claim 16, wherein the at least one grounding wire is positioned between the first conductive shielding layer and the second conductive shielding layer and is in electrical contact with at least one of the first conductive shielding layer and the second conductive shielding layer.

18. The cable according to claim 17, wherein each of the first conductive shielding layer and the second conductive shielding layer has an insulation tape and a conductive layer adhered to the insulation tape, the conductive layers of the first conductive shielding layer and the second conductive shielding layer face each other and contact the at least one grounding wire.

19. A cable assembly, comprising:
at least two cables, each of the cables including:
at least two conductive wire cores spaced apart from each other and extending in a longitudinal direction of the cable;
an interior insulation structure circumferentially wrapped around and contacting each of the at least two conductive wire cores to fix the at least two conductive wire cores, the interior insulation structure being a foamed insulation structure in which the at least two conductive wire cores are fixedly maintained;
an internal insulation layer wrapped over and contacting the interior insulation structure on an outer side of the interior insulation structure;
a first conductive shielding layer wrapped over the internal insulation layer on an outer side of the internal insulation layer; and
an external insulation layer wrapped over an outside of the first conductive shielding layer;
an electromagnetic shielding structure circumferentially wrapped around an outside of the at least two cables; and
an outer sheath sleeved on an outside of the electromagnetic shielding structure.

20. The cable assembly according to claim 19, further comprising a buffering layer provided between the electromagnetic shielding structure and the outer sheath, and/or a filler filled in a space between the at least two cables inside the electromagnetic shielding structure.
